(19) United States
(12) Patent Application Publication
(10) Pub. No.: US 2026/0091787 A1
(43) Pub. Date: Apr. 2, 2026

(54) DRIVER FITNESS TEST

(71) Applicant: TOYOTA RESEARCH INSTITUTE, INC., Los Altos, CA (US)

(72) Inventors: SIMON A.I. STENT, Oxford (GB); John H. Gideon, Cincinnati, OH (US); Kimimasa Tamura, Cambridge, MA (US); Guy Rosman, Newton, MA (US)

(73) Assignees: TOYOTA RESEARCH INSTITUTE, INC., Los Altos, CA (US); TOYOTA JIDOSHA KABUSHKI KAISHA, Toyota-Shi (JP)

(21) Appl. No.: 18/945,434

(22) Filed: Nov. 12, 2024

Related U.S. Application Data
(60) Provisional application No. 63/701,311, filed on Sep. 30, 2024.

(51) Int. Cl. B60W 40/08

(52) U.S. Cl. CPC B60W 40/08; B60W 2040/0836; B60W 2040/0872

(57) ABSTRACT

A system includes sensors that determine one or more attributes associated with associated with an occupant within a vehicle. The system includes one or more datastores, one or more processors, and a memory storing instructions that, when executed by the one or more processors, cause the system to perform operations. The operations include displaying one or more stimuli on a screen within an interior of the vehicle; prompting the occupant to perform one or more visual or motor actions in response to the one or more stimuli; obtaining the one of more attributes; assessing the one or more attributes to determine a level of fitness of the occupant; and based on the level of fitness, activating or deactivating one or more functions within the vehicle.

### CROSS-REFERENCE TO RELATED APPLICATIONS

This application claims the benefit of U.S. Provisional Application No. 63/701,311 filed Sep. 30, 2024 and which is hereby incorporated herein by reference in its entirety.

### TECHNICAL FIELD

The present disclosure relates generally to assessing driver fitness, in particular, a series of tests that perform driver fitness tests based on natural body movements.

### DESCRIPTION OF RELATED ART

In order to drive a vehicle, a driver must be unimpaired. To ensure safety, a driver that has been inebriated by alcohol should not be driving. Breathalyzers may detect a driver's breath alcohol concentration (BrAC). If the BrAC is within the legal limits, the vehicle may be programmed to permit operation. However, if the BrAC is outside of the legal limits, the vehicle may be prohibited from operating.

### BRIEF SUMMARY OF THE DISCLOSURE

According to various embodiments of the disclosed technology, a system comprises one or more sensors configured to determine one or more attributes associated with an occupant within a vehicle; one or more datastores; and one or more processors. The system comprises a memory storing instructions that, when executed by the one or more processors, cause the system to perform operations. The operations include displaying one or more stimuli on a screen within an interior of the vehicle; prompting the occupant to perform one or more visual or motor actions in response to the one or more stimuli; obtaining the one of more attributes; assessing the one or more attributes to determine a level of fitness of the occupant; and based on the level of fitness, activating or deactivating one or more functions within the vehicle.

In some embodiments, the prompting of the occupant to perform the one or more visual or motor actions is associated with a gaze tracking test, a fixed gaze test, a split choice reaction test, or a silent reading test.

In some embodiments, the assessing the one or more attributes is based on an inferred degree of reactivity of the occupant.

In some embodiments, the assessing the one or more attributes is based on a degree of steadiness of eye movements of the occupant.

In some embodiments, the one or more attributes are based on a degree of steadiness of eye movements of the occupant.

In some embodiments, the one or more attributes are based on a degree of reactivity of hands of the occupant applying a force to an object within an interior of the vehicle.

In some embodiments, the one or more attributes are based on a degree of steadiness in a gaze of the occupant.

In some embodiments, the activating or deactivating one or more functions comprises selectively activating a driver assistance functionality in response to determining that the occupant is at least partially impaired.

In some embodiments, the assessing the one or more attributes to determine a level of fitness comprises outputting a confidence level associated with the determined level of fitness.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example of an all-wheel drive hybrid vehicle with which embodiments of the systems and methods disclosed herein may be implemented.

FIG. 3 illustrates an example architecture for performing a driver fitness assessment test, in accordance with one embodiment of the systems and methods described herein.

FIGS. 4A-4G illustrate example architectures for performing a driver fitness assessment test, in accordance with one embodiment of the systems and methods described herein, which may be implemented in conjunction with the example architecture illustrated in FIG. 3.

FIG. 5 is an example computing component that may be used to implement various features of embodiments described in the present disclosure.

The figures are not exhaustive and do not limit the present disclosure to the precise form disclosed.

### DETAILED DESCRIPTION

A system is mounted in an interior of a vehicle and performs a series of tests on a driver within an interior of a vehicle (e.g., an ego vehicle), prior to driving. Although the foregoing refers to drivers, it is understood that the testing, and/or other implementations described, are not limited to drivers. The testing and/or other implementations described may be performed on other occupants of a vehicle such as passengers. The series of tests cover different visuomotor responses, which are important for safe driving and are particularly likely to be affected by alcohol or other forms of intoxication or impairment. However, the tests assess different forms of impairment, not just intoxication. For example, at least some of the tests may assess impairment due to other factors such as substances (e.g., drugs) or physical conditions (e.g., exhaustion). In addition, although the tests are described as applying to a driver, the tests are not limited to being applied to a driver. Rather, the tests can be applied to any occupants of a vehicle. Some of the tests involve a sensor, such as a camera, that monitors the driver's eyes and/or other body parts. Some of the tests also involve pressing buttons, which may be located on steering wheels. Some of the tests involve a driver viewing a display, such as a wraparound screen or a virtual screen.

The tests may include any of a gaze tracking test, a fixed gaze test, a split choice reaction test, and a silent reading test. For example, the gaze tracking test includes prompting the driver to follow a displayed object on a display as the object moves laterally, while the sensor observes the driver's eyes. The test measures involuntary eye movements, or nystagmus, which can become more pronounced when someone is intoxicated.

Meanwhile, the fixed gaze test measures a driver's ability to maintain a steady gaze on a displayed object at various head angles without the eye generating extraneous movements such as square wave jerks or nystagmus. When intoxicated, a person's nervous system may display a breakdown in smooth and accurate control of eye movements. This breakdown in the smooth control of eye movements may result in an inability to hold the eyes steady, which results in observable changes of impaired oculomotor functioning.

Next, the split choice reaction test assesses how quickly someone can respond to different stimuli, each of which requires a different response. This test may be a simple reaction time test, in which the driver pushes a button as quickly as possible after a light is turned on, and/or a choice reaction time test, in which a driver is prompted to push a button when a symbol is displayed and push a different button when a different symbol is displayed. The symbols are meant to mimic actual obstacles encountered on a road. The split choice reaction test may be performed without sensors to monitor the driver.

Furthermore, the silent reading test assesses a person's ability to read and comprehend text such as vehicle-related information or warnings on an instrument cluster. This test involves using one or more sensors to track the driver's eye movements.

A machine learning model is trained for a given driver over the course of multiple repeats of one or more of the above tests. The machine learning model may include a regression model or a classification model. This machine learning model can learn baseline parameters indicative of performance on tests for the given driver, and predict anomalous behaviors which are suggestive of a lower fitness to drive. For example, when one or more results of tests fall outside of the baseline parameters, then the model may predict an existence of anomalous behavior indicative of impairment, and/or a confidence level of the prediction.

The system and/or the machine learning model may classify the driver as either receiving a pass (e.g., able to operate the vehicle), a fail (e.g., unable to operate the vehicle), or an unclear result. If the driver is classified as an unclear result, additional testing may be performed until a pass or fail score is determined.

In the event of a failed result, the system may transmit a notification to another entity, such as a caretaker, a guardian, a parent, a local authority, or a hospital. In some embodiments, the system may at least partially prevent operation of one or more vehicle systems. For example, depending on an extent of the failed result (e.g., exhibiting partial impairment or mild impairment), the system may modify one or more vehicle systems to disable certain functionality such as turns of a high degree and/or program additional limitations, such as speed limitations and/or location limitations of where the vehicle may drive. Additionally or alternatively, the system may activate one or more additional protection systems such as lane departure systems.

In some embodiments, a frequency and/or a timing of administering the one or more tests may be programmed, for example, based on a degree of safety of a planned navigation path and/or based on a history of the driver. For example, if the driver is frequently impaired, then the one or more tests may be administered more frequency. As another example, if the planned navigation path has a high degree of danger, the one or more tests may be more likely to be administered and/or a frequency of administering the one or more tests may be greater.

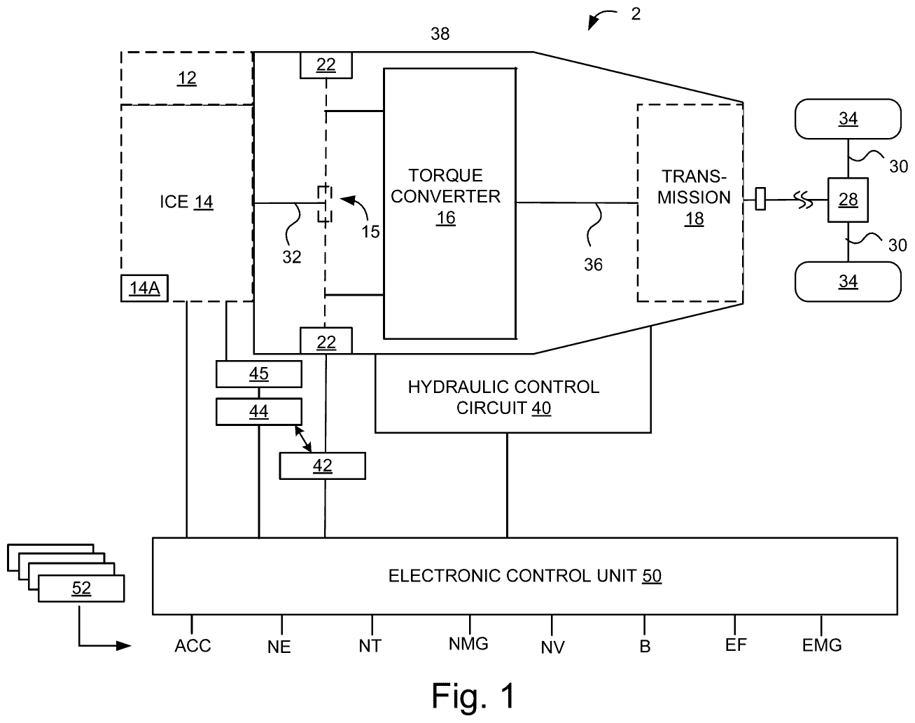

The systems and methods disclosed herein may be implemented with any of a number of different ego vehicles and ego vehicle types. For example, the systems and methods disclosed herein may be used with automobiles, trucks, motorcycles, recreational vehicles and other like on- or off-road vehicles. In addition, the principles disclosed herein may also extend to other vehicle types as well. An example hybrid electric vehicle (HEV) in which embodiments of the disclosed technology may be implemented as an ego vehicle and is illustrated in FIG. 1. Although the example described with reference to FIG. 1 is a hybrid type of ego vehicle, the systems and methods for driver fitness assessment can be implemented in other types of ego vehicles including gasoline- or diesel-powered vehicles, fuel-cell vehicles, electric vehicles, or other vehicles.

FIG. 1 illustrates a drive system of an ego vehicle 2 that may include an internal combustion engine 14 and one or more motors 22 (e.g., electric motors, which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, ego vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, ego vehicle 2 relies on the motive force generated at least by internal combustion engine 14, and a clutch 15 may be included to engage engine 14. In the EV travel mode, ego vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in ego vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit 40. When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, ego vehicle 2 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50 execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in ego vehicle 2. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, ego vehicle 2 can include a plurality of sensors 52 that can be used to detect various conditions internal or external to the vehicle and provide sensed conditions to electronic control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+cooling system 12) efficiency, acceleration, ACC, etc. Electronic control unit 50 may also receive signals indicative of occupant fitness. Here, an occupant may refer to a driver or a passenger. These signals may include, without limitation, a measure of head or eye movement or a degree of head or eye stability.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The sensors 52 may be within an interior or on an exterior of the ego vehicle 2. The sensors 52 may also include capturing sensors, which capture sensor data within the ego vehicle 2 or within surroundings of the ego vehicle 2. In some embodiments, additional sensors may not be directly connected to the ego vehicle 2, but rather, may be located on a different entity, such as a drone or a stationary landmark such as a traffic light.

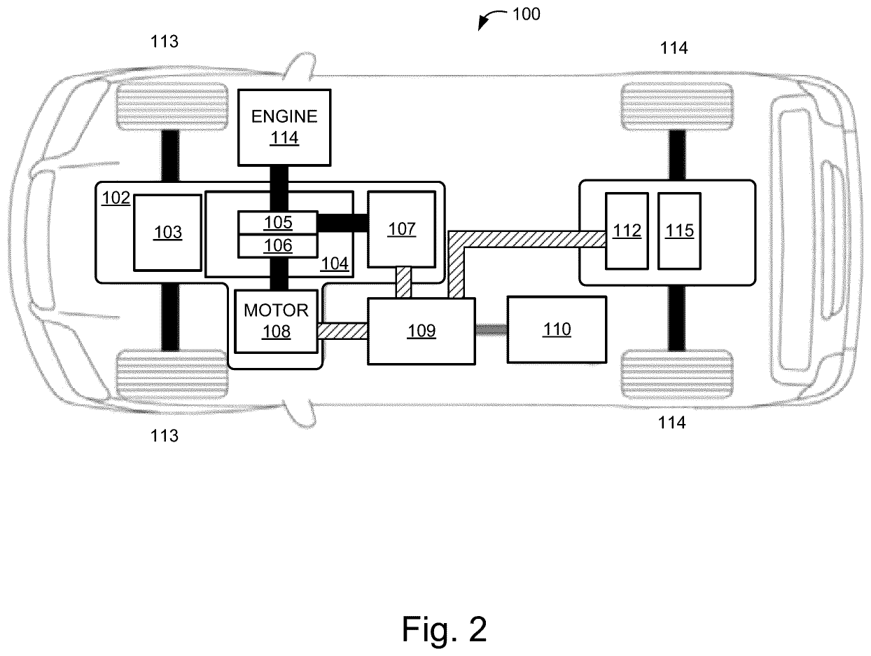

FIG. 2 is another example of an ego vehicle with which systems and methods for assessing occupant fitness can be implemented. The example illustrated in FIG. 2 is also that of a hybrid vehicle drive system of a vehicle 100 that may also include an engine 114 (e.g., internal combustion engine 14) and one or more electric motors 108, 112 (e.g., motors 22) as sources of motive power. In this example, a hybrid transaxle assembly 102 includes front differential 103, a compound gear unit 104, a motor 108, and a generator 107. Compound gear unit 104 includes a power split planetary gear unit 105 and a motor speed reduction planetary gear unit 106. This example vehicle also includes front and rear drive motors 108, 112, an inverter with converter assembly 109, battery 110 (which may include multiple batteries), and a rear differential 115. Hybrid transaxle assembly 102 enables power from engine 101, motor 108, or both to be applied to front wheels 113 via front differential 103.

Inverter with converter assembly 109 inverts DC power from battery 110 to create AC power to drive AC motors 108, 112. In embodiments where motors 108, 112 are DC motors, no inverter is required. Inverter with converter assembly 109 also accepts power from generator 107 (e.g., during engine charging) and uses this power to charge battery 110.

The examples of FIGS. 1 and 2 are provided for illustration purposes only as examples of vehicle systems with which embodiments of the disclosed technology may be implemented. One of ordinary skill in the art reading this description will understand how the disclosed embodiments can be implemented with vehicle platforms.

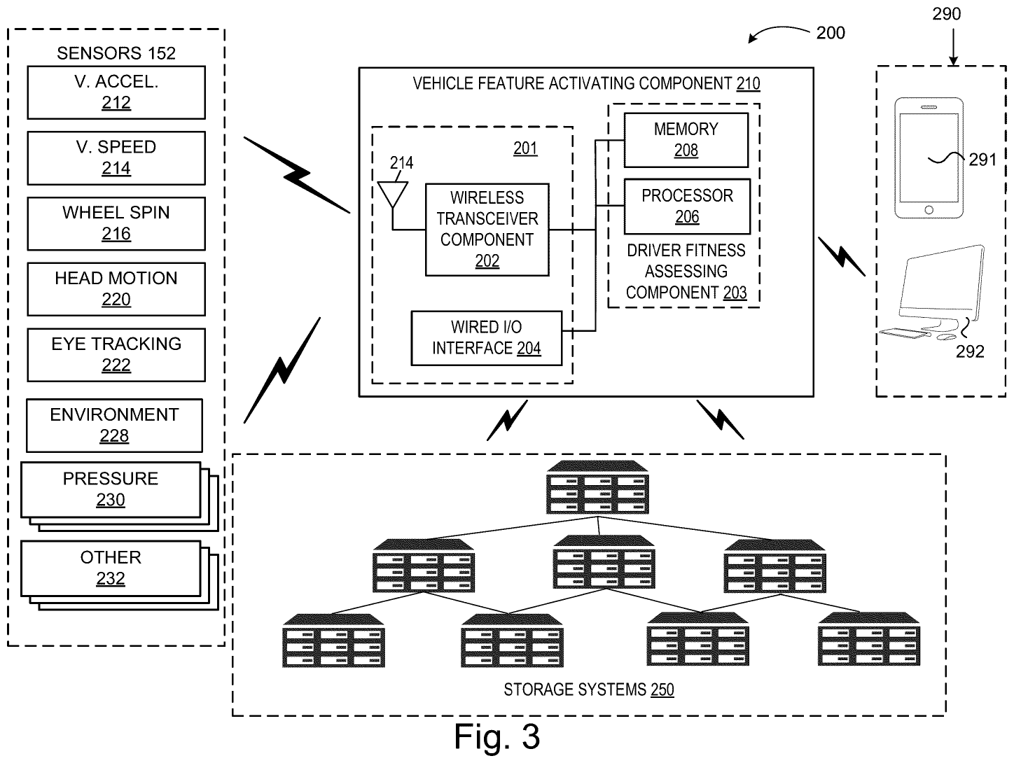

FIG. 3 illustrates an example architecture for adaptively and selectively assessing driver fitness, which may be performed at least in part by sensors 52 illustrated in FIG. 1, in accordance with one embodiment of the systems and methods described herein. Referring now to FIG. 3, in this example, driver fitness assessing system 200 includes a vehicle feature activating component 210, which selectively activates or deactivates certain features of a vehicle depending on a driver fitness. For example, if the driver fitness is determined to be impaired, then the vehicle feature activating component may control the vehicle to prohibit certain vehicle actions and/or activate addition vehicle protection systems such as Intelligent Speed Assistance (ISA) and/or lane departure warning systems. The driver fitness assessing system 200 may include a plurality of sensors 152, one or more storage systems 250 which may include remote servers, and one or more other devices 290 which may external or internally located within the vehicle 2, or external to the vehicle feature activating component 210. Sensors 152, storage systems 250, and one or more other devices 290 can communicate with the vehicle feature activating component 210 via a wired or wireless communication interface. Although sensors 152, storage systems 250 and one or more other devices 290 are depicted as communicating with vehicle feature activating component 210, they can also communicate with each other as well as with other vehicle systems. In some embodiments, the one or more other devices 290 include one or more different computing or mobiles devices 291 and 292, and may be configured to receive a subset (e.g., a portion or all of) results of one or more driver fitness tests, either in real-time or in a delayed manner via V2N communication.

Sensors 152 can include, for example, sensors 52 such as those described above with reference to the example of FIG. 1. Sensors 152 can include additional sensors. In the illustrated example, sensors 152 may obtain navigation and/or other related data such as behavioral and/or interaction data of occupants within the ego vehicle 2. The sensors 152 may include vehicle acceleration sensors 212, vehicle speed sensors 214, wheelspin sensors 216 (e.g., one for each steering wheel), head motion sensors 220 to detect rotational and/or translational motion of a head of a driver within the ego vehicle 2, eye tracking sensors 222 to detect eye movements of the driver, and environmental sensors 228 (e.g., to detect traffic density, speed of surrounding traffic, weather, air quality, and/or other environmental conditions). The environmental sensors 228 may be used to determine an extent of testing to be performed. For example, if traffic density is high and/or the environment has hazy conditions, then more extensive testing may be performed. Pressure sensors 230 may detect, for example, when a button has been contacted and/or pushed. Additional sensors 232 can also be included as may be appropriate for a given implementation of driver fitness assessing system 200. The sensors 152 may be configured to detect and/or alert for any indications of anomalous behavior, as will be described below.

Storage systems 250 may include one or more remote servers. The remote servers may store driver data, including baseline conditions (e.g., typical performance measures of different drivers when not impaired and when impaired). In some embodiments, the baseline conditions may correspond to different times of day, different locations, and/or other conditions. For example, a particular driver may exhibit different test results (e.g., reaction times) depending on a time of day and/or depending on a location.

Vehicle feature activating component 210 can be implemented as an ECU or as part of an ECU such as, for example electronic control unit 50. In other embodiments, vehicle feature activating component 210 can be implemented independently of the ECU.

Vehicle feature activating component 210 in this example includes a communication component 201, and a driver fitness assessing component 203 (including a processor 206 and memory 208 in this example). Components of vehicle feature activating component 210 are illustrated as communicating with each other via a data bus, although other communication in interfaces can be included.

The driver fitness assessing component 203 may predict a level of driver fitness and/or a confidence level of the prediction using one or more tests. In some embodiments, selection among the one or more tests may be based on the driver. This is because one test may be more reliable in determining driver fitness for a particular driver. For example, a particular driver may have a weak gaze and/or difficult to detect head movements even when unimpaired, and therefore, gaze tracking and fixed gaze tests may not be effective in detecting driver fitness for that particular driver.

The driver fitness assessing component 203 may obtain sensor data from the one or more sensors 152 indicative of eye movements, gaze patterns, and/or button pushing.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store any information used to perform a driver fitness test, for processor 206 as well as any other suitable information. Memory 208 can be made up of one or more modules of one or more different types of memory, and may be configured to store data and other information as well as operational instructions that may be used by the processor 206.

Although the example of FIG. 3 is illustrated using processor and memory components, as described below with reference to components disclosed herein, driver fitness assessing component 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up vehicle feature activating component 210.

Communication component 201 includes either or both a wireless transceiver component 202 with an associated antenna 205 and a wired I/O interface 204 with an associated hardwired data port (not illustrated). As this example illustrates, communications with vehicle feature activating component 210 can include either or both wired and wireless communication components 201. Wireless transceiver component 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver component 202 and is used by wireless transceiver component 202 to transmit radio signals wirelessly to wireless equipment with which it is connected and to receive radio signals as well. These RF signals can include information of almost any sort that is sent or received by vehicle feature activating component 210 to/from other entities such as sensors 152 and storage systems 250.

Wired I/O interface 204 can include a transmitter and a receiver (not shown) for hardwired communications with other devices. For example, wired I/O interface 204 can provide a hardwired interface to other components, including sensors 152 and storage systems 250. Wired I/O interface 204 can communicate with other devices using Ethernet or any of a number of other wired communication protocols whether standardized, proprietary, open, point-to-point, networked or otherwise.

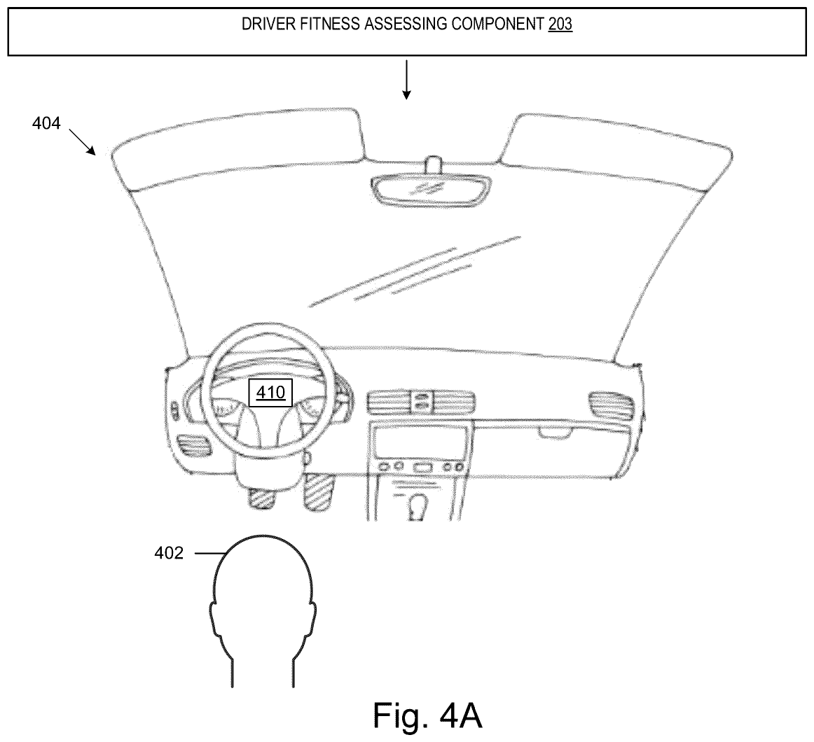

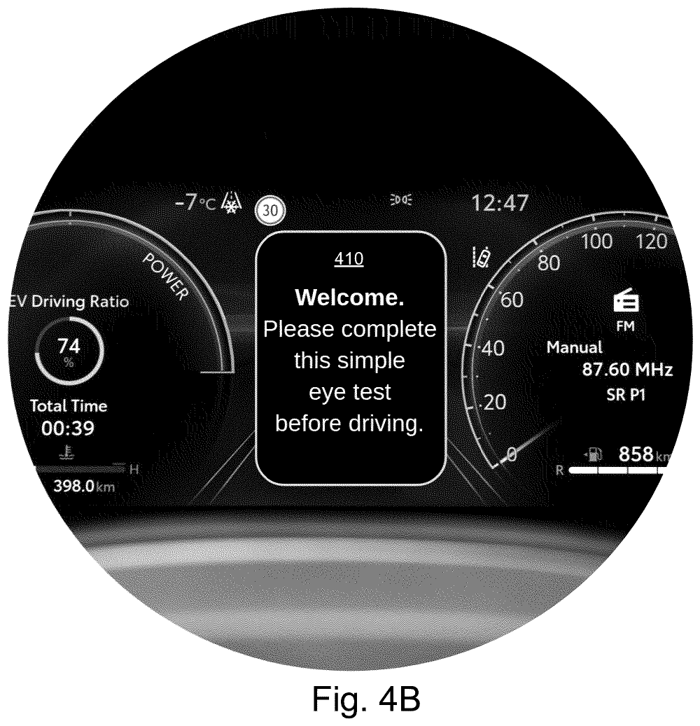

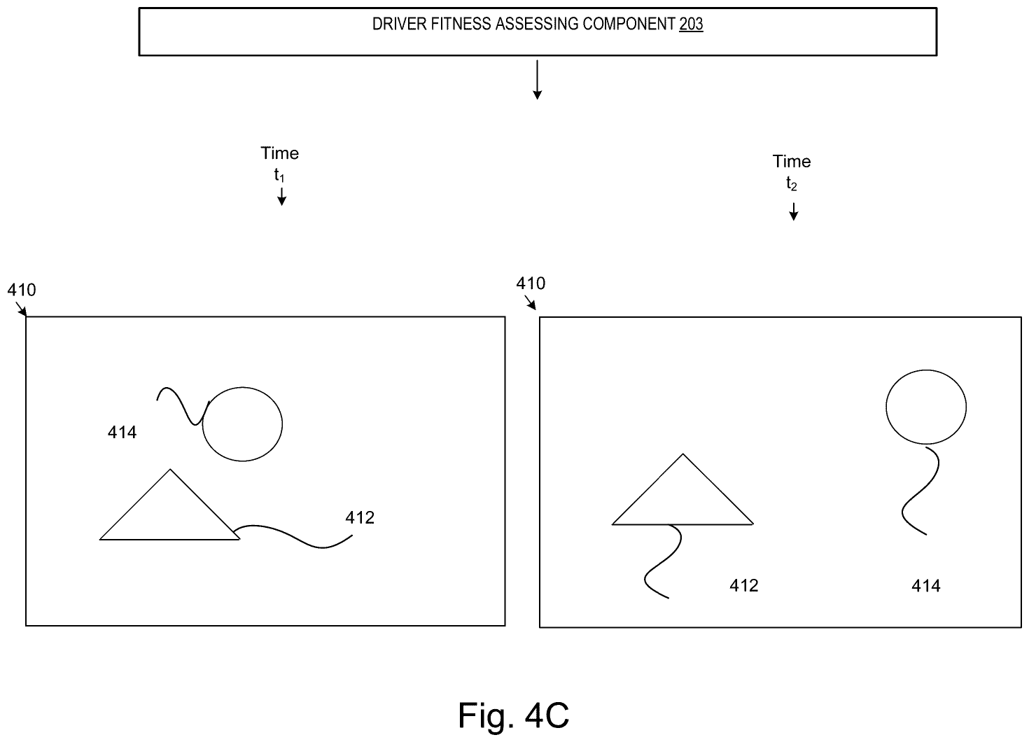

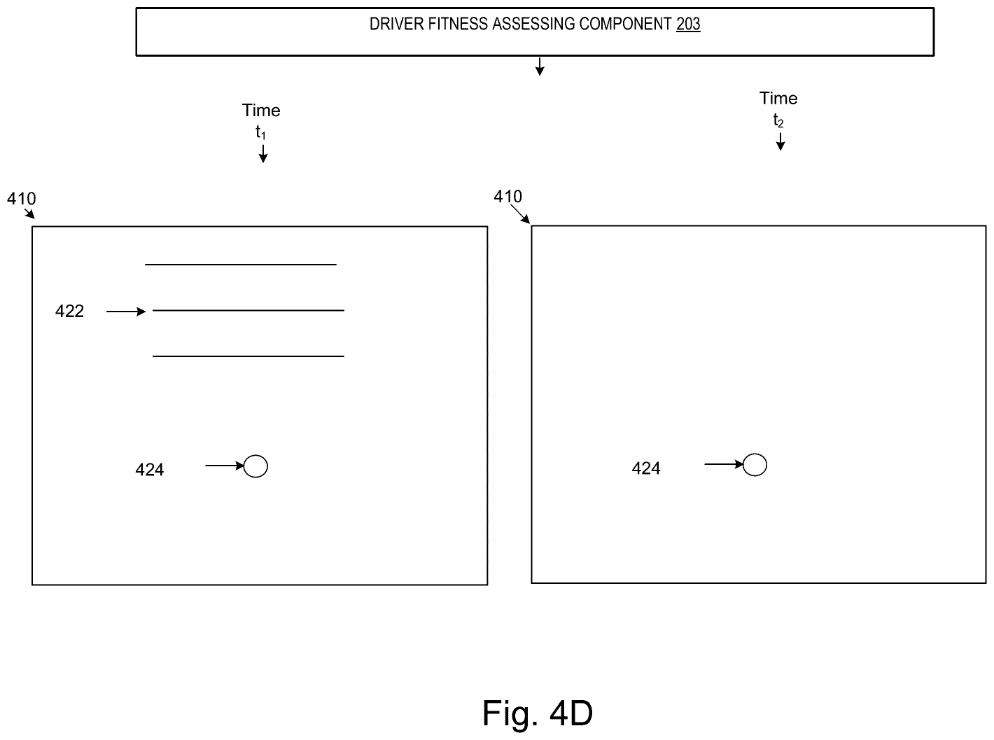

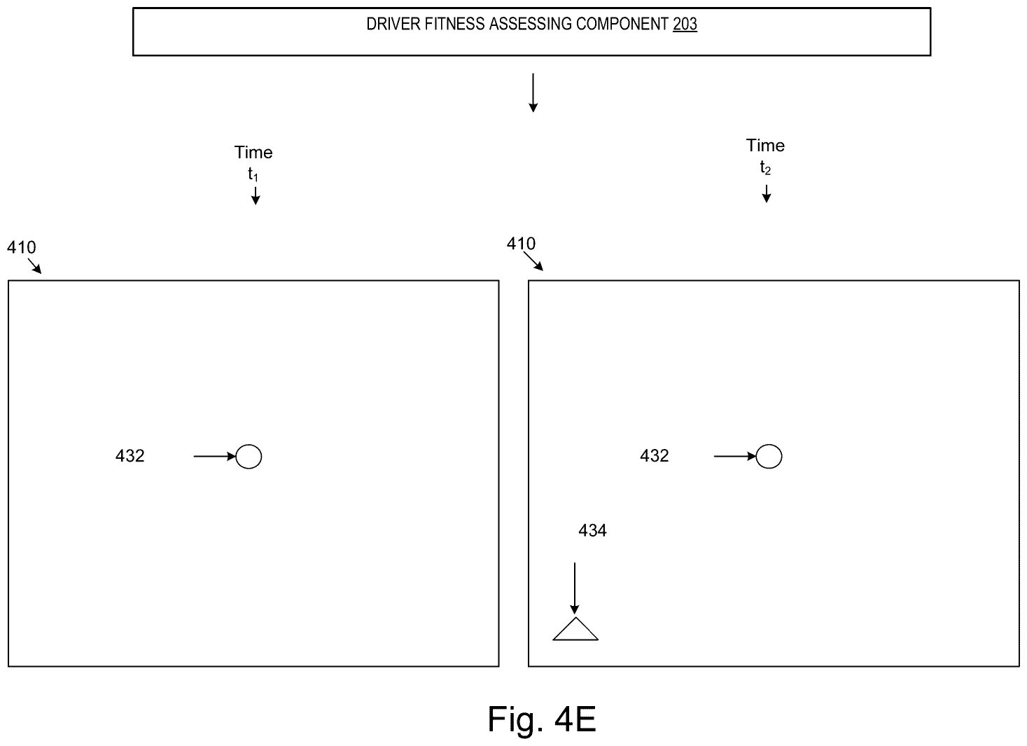

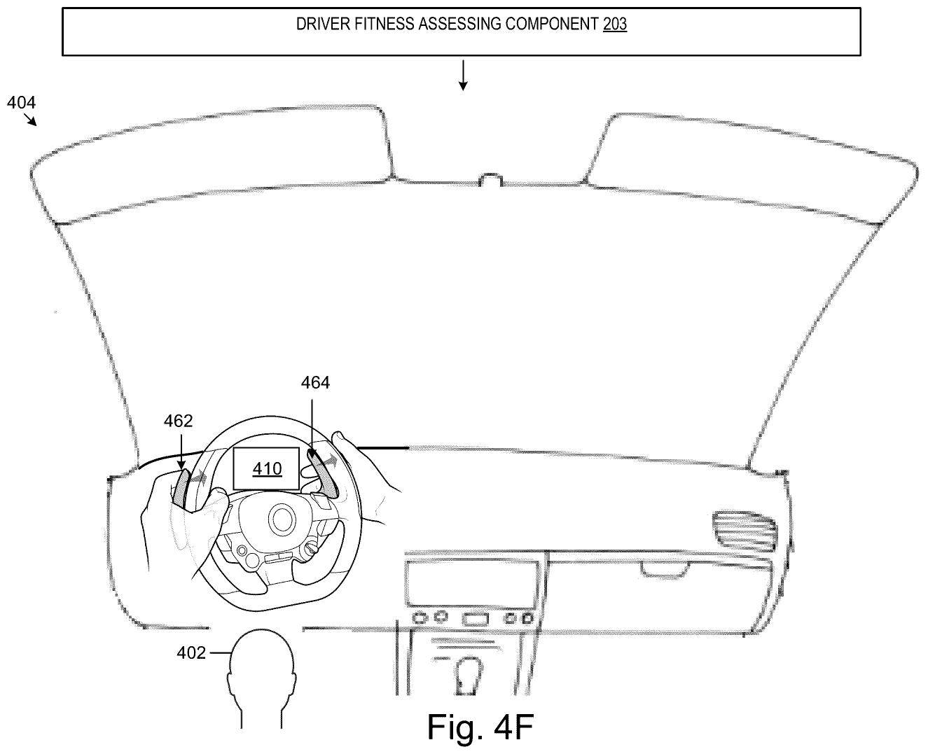

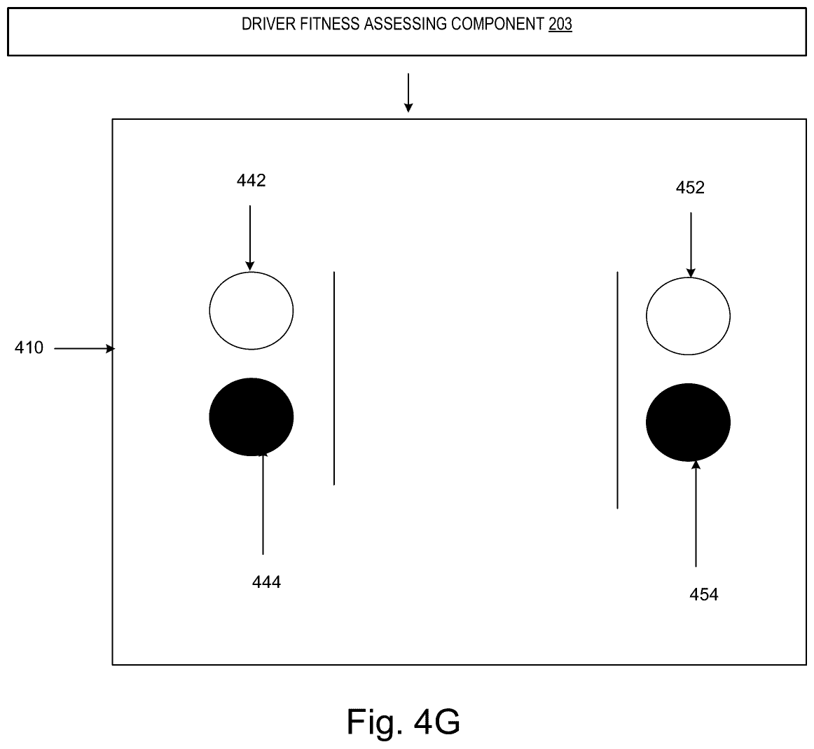

FIGS. 4A-4G illustrate embodiments of the driver fitness assessing component 203, implemented within a vehicle interior environment 404. In some embodiments, the principles in FIGS. 4A-4G may be applied in conjunction with FIG. 3. FIG. 4A illustrates the vehicle interior environment 404 in which a driver fitness is assessed. A driver 402 is looking at a screen 410. In some embodiments, the screen 410 is located in or otherwise associated with an instrument panel or instrument cluster, or media console. FIG. 4B illustrates the screen 410 in a context of an instrument panel.

In FIG. 4C, the driver fitness assessing component 203 performs a gaze tracking test, in which the driver fitness assessing component 203 tracks eye movements of a driver 402 during a time interval, for example from time t₁ to time t₂. At time t₁, the driver 402 is looking at the screen 410 that includes a plurality of objects 412 and 414. The driver holds his/her head steady in a direction of the object 412, while moving his/her eyes as the object 414 moves. In some embodiments, the object 412 may be stationary. At time t₂, the driver 402 holds his/her head in a steady, fixed position while moving his/her eyes as the object 414 moves. In FIG. 4A, the object 414 may move laterally from left to right or right to left. Other embodiments may also be envisioned, such as the object 414 moving up and down. The driver fitness assessing component 203 may determine a degree of steadiness of the driver's eyes as the driver's eyes are following the object 414 and a degree to which the eyes of the driver 402 are properly following the object 414.

In FIG. 4D, the driver fitness assessing component 203 performs a silent reading test, in which the driver fitness assessing component 203 tracks eye movements of the driver 402 while the driver 402 is reading textual information 422 on the screen 410 at a time t₁. In some embodiments, different textual information 422 may appear and disappear at different times. When the textual information 422 disappears, at a time t₂, the driver 402 may look at an object 424. When the textual information 422 appears, the driver may read the textual information 422. In some embodiments, even when the textual information 422 appears, the object 424 may still be present on the screen 410. The driver fitness assessing component 203 may track eye movements of the driver 402 as the driver 402 alternates between looking at the textual information 422 and the object 424. The driver fitness assessing component 203 may determine a degree of steadiness of the driver's eyes as the driver's eyes are alternating between the textual information 422 and the object 424 and a degree of reactivity (e.g., how timely the eyes of the driver 402 are reacting to the textual information 422 appears and disappears).

In FIG. 4E, the driver fitness assessing component 203 performs a fixed gaze test, in which the driver fitness assessing component 203 tracks eye movements of the driver 402 while the driver 402 is fixing his/her eyes towards an object 432 on the screen 410 at time t₁. In some embodiments, at time t₂, an object 434 may appear on the screen 410. The driver 402 may move his/her head towards the object 434 while fixing his/her eyes on the object 432. The driver fitness assessing component 203 may detect a degree of steadiness of the eyes of the driver 402 even when the driver 402 is moving his/her head towards the object 434.

FIG. 4F illustrates a context of the vehicle interior environment 404 including certain buttons such as paddle shifters 462 and 464. The paddle shifters 462 and 464 may be implemented in a reaction test, such as a split choice reaction test, in which the driver fitness assessing component 203 detects a degree of reactivity of a movement, such as hand movements, of a driver in response to certain stimuli. The driver fitness assessing component 203 may assess a degree of reactivity of the driver 402 pressing the paddle shifters 462 and 464 on a steering wheel. FIG. 4G illustrates an implementation of a reaction test, implemented in conjunction with FIG. 4F, in which objects 442, 444, 452, and 454 may be disposed on the screen 410, and may alternate between active and inactive states. For example, objects 442 and 452 may represent green lights and objects 444 and 454 may represent red lights. When the object 442 is in an active state (e.g., the left green light is on) the driver may press the paddle shifter 462. When the object 442 is in an inactive state and the object 444 is in an active state (e.g., the left red light is on) the driver may release the paddle shifter 462. When the object 452 is in an active state (e.g., the right green light is on) the driver may press the paddle shifter 464. When the object 454 is in an active state (e.g., the right red light is on) the driver may release the paddle shifter 464. Therefore, the driver fitness assessment component 203 may determine a response time of pressing the paddle shifters 462 and 464 in response to changing stimuli.

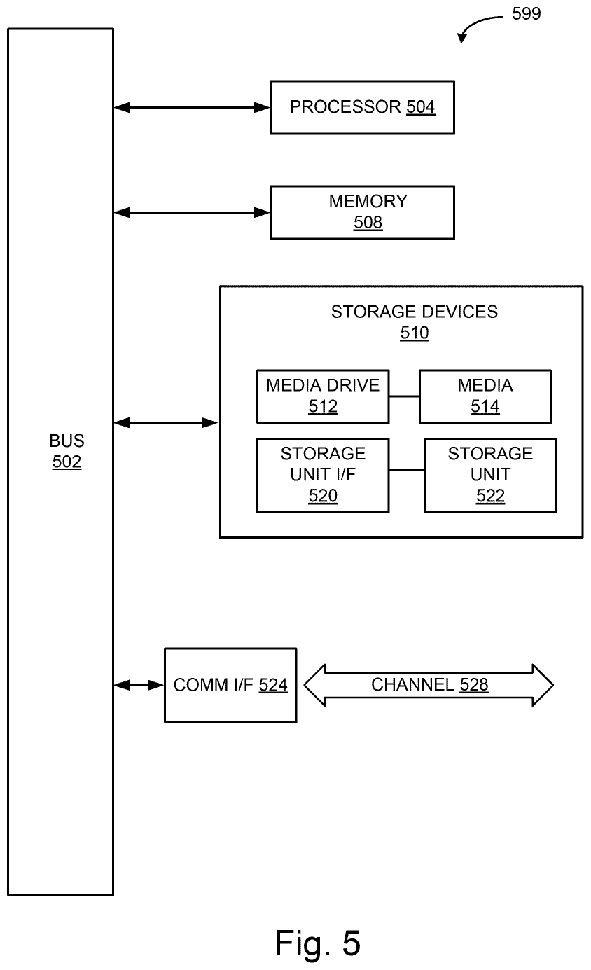

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Reference to A “and” B may be construed to also encompass the scenario of A “or” B. Reference to A “or” B may be construed to also encompass the scenario of A “and” B. Any reference to a “threshold” or “sufficiency” may be construed to encompass any applicable value or degree. For example, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity or degree may be construed as qualitatively satisfying some condition, such as presence of one or more common features. Any reference to sufficiently similar may also be construed to encompass same or similar meanings as satisfying a threshold.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
one or more sensors configured to determine one or more attributes associated with an occupant within a vehicle;
one or more datastores; and
one or more processors;
a memory storing instructions that, when executed by the one or more processors, cause the system to perform:
displaying one or more stimuli on a screen within an interior of the vehicle;
prompting the occupant to perform one or more visual or motor actions in response to the one or more stimuli;
obtaining the one of more attributes;
assessing the one or more attributes to determine a level of fitness of the occupant; and
based on the level of fitness, activating or deactivating one or more functions within the vehicle.

2. The system of claim 1, wherein the prompting of the occupant to perform the one or more visual or motor actions is associated with a gaze tracking test, a fixed gaze test, a split choice reaction test, or a silent reading test.

3. The system of claim 1, wherein the assessing the one or more attributes is based on an inferred degree of reactivity of the occupant.

4. The system of claim 1, wherein the assessing the one or more attributes is based on a degree of steadiness of eye movements of the occupant.

5. The system of claim 1, wherein the one or more attributes are based on a degree of steadiness of eye movements of the occupant.

6. The system of claim 1, wherein the one or more attributes are based on a degree of reactivity of hands of the occupant.

7. The system of claim 6, wherein the one or more attributes are based on a degree of reactivity of hands of the occupant applying a force to an object within an interior of the vehicle.

8. The system of claim 1, wherein the one or more attributes are based on a degree of steadiness in a gaze of the occupant.

9. The system of claim 1, wherein the activating or deactivating one or more functions comprises selectively activating a driver assistance functionality in response to determining that the occupant is at least partially impaired.

10. The system of claim 1, wherein the assessing the one or more attributes to determine a level of fitness comprises outputting a confidence level associated with the determined level of fitness.

11. A vehicle control system, comprising:
a processor; and
a memory coupled to the processor to store instructions, which when executed by the processor, cause the processor to perform operations, the operations comprising:
displaying one or more stimuli on a screen within an interior of the vehicle;
prompting the occupant to perform one or more visual or motor actions in response to the one or more stimuli;
obtaining the one of more attributes;
assessing the one or more attributes to determine a level of fitness of the occupant; and
based on the level of fitness, activating or deactivating one or more functions within the vehicle.

12. The vehicle control system of claim 11, wherein the prompting of the occupant to perform the one or more visual or motor actions is associated with a gaze tracking test, a fixed gaze test, a split choice reaction test, or a silent reading test.

13. The vehicle control system of claim 11, wherein the assessing the one or more attributes is based on an inferred degree of reactivity of the occupant.

14. The vehicle control system of claim 11, wherein the assessing the one or more attributes is based on a degree of steadiness of eye movements of the occupant.

15. The vehicle control system of claim 11, wherein the one or more attributes are based on a degree of steadiness of eye movements of the occupant.

16. The vehicle control system of claim 11, wherein the one or more attributes are based on a degree of reactivity of hands of the occupant.

17. The vehicle control system of claim 16, wherein the one or more attributes are based on a degree of reactivity of hands of the occupant applying a force to an object within an interior of the vehicle.

18. The vehicle control system of claim 11, wherein the one or more attributes are based on a degree of steadiness in a gaze of the occupant.

19. The vehicle control system of claim 11, wherein the activating or deactivating one or more functions comprises selectively activating a driver assistance functionality in response to determining that the occupant is at least partially impaired.

20. A non-transitory machine-readable medium having instructions stored therein, which when executed by a processor, cause the processor to perform operations, the operations comprising:
displaying one or more stimuli on a screen within an interior of the vehicle;
prompting the occupant to perform one or more visual or motor actions in response to the one or more stimuli;
obtaining the one of more attributes;
assessing the one or more attributes to determine a level of fitness of the occupant; and
based on the level of fitness, activating or deactivating one or more functions within the vehicle.
